(19) United States
(12) Patent Application Publication
(10) Pub. No.: US 2026/0103345 A1
(43) Pub. Date: Apr. 16, 2026

(54) PROTECTIVE PART FOR A CONVEYOR

(71) Applicant: EXOTEC PRODUCT FRANCE, CROIX (FR)

(72) Inventors: Bastien CAGNAC, CROIX (FR); Jérémie FRELIEZ, VILLENEUVE D'ASCQ (FR); Damien VIVES, CROIX (FR)

(73) Assignee: EXOTEC PRODUCT FRANCE, CROIX (FR)

(21) Appl. No.: 19/247,076

(22) Filed: Jun. 24, 2025

(30) Foreign Application Priority Data
Jun. 25, 2024 (FR) FR2406809

(51) Int. Cl. B65G 13/11; B65G 13/07

(52) U.S. Cl. CPC B65G 13/11; B65G 13/07; B65G 2207/40

(57) ABSTRACT

A protection part intended to equip a conveyor includes two lateral profiled members between which a plurality of rollers extend transversely, each roller being mounted to pivot relative to the lateral profiled members via a mounting shaft, at least one of the rollers being motor-driven, and at least one drive belt connecting two of the rollers and defining pinch zones. The protection part includes a base with an opening through which the roller shaft passes, the base then being located between the roller and the profiled member, two protection walls extending on respective sides of the roller from said base so as to prevent access to the pinch zones, and a fixing element for retaining said protection part on the lateral profiled member.

### TECHNICAL FIELD

The field of the present disclosure is that of conveyors, notably conveyors used in order preparation warehouses.

### BACKGROUND

It is known to use roller conveyors for the transport of orders. The conveyors generally comprise a structure comprising lateral profiled members on which rollers are rotatably mounted. The rollers are typically arranged parallel to one another between the lateral profiled members, each roller being for example mounted so as to pivot about a fixed shaft. End portions of the shaft project from the two longitudinal ends of the roller and are fixed to respective profiled members, penetrating through respective openings in the lateral profiled members. One of the rollers is typically driven in rotation by an actuator and its rotation is transmitted to the other rollers by belts connecting the rollers two by two. The spaces between the upper and lower runs of the belts and the rollers constitute pinch zones. These conveyors are often accessible by operators for the preparation of orders and there remains a risk of injury in these pinch zones, in particular in zones where the belt and the roller can trap the fingers and crush them against the roller.

As a safety measure, these types of conveyor are covered by a standard that makes it obligatory to protect these zones. There now exist solutions for addressing these requirements.

The document EP3959157 describes a first type of protection element for conveyors: the conveyor comprising two adjacent rollers connected to one another by a drive belt. The protection element is in floating geometrical correspondence between the two adjacent rollers and further includes a protuberance on its upper part that fills the space between the two adjacent rollers and the drive belt.

A similar protection element is described in the document US20230102050. In that document, the protection element is clipped between the two adjacent rollers and includes an upper part designed to reduce the space between two adjacent rollers and the drive belt connecting those rollers to one another. The protection element further includes a groove adapted to receive the drive belt.

This type of protection element arranged between two adjacent rollers has the particular drawback that it cannot be adapted to different spacings between two rollers.

Another type of protection element is known from the document EP3699113 in particular. In this case, the protection element includes a base in which is formed a notch opening on a lower edge of the base and including an arcuate housing the diameter of which matches that of the shaft of the roller, the notch being configured to be clipped over the shaft of the roller. The protection element further includes an upper surface to fill in the space between the roller and a drive belt engaged around said roller. Furthermore, the protection element includes lateral attachment means enabling it to be connected to two other protection elements mounted on the adjacent rollers, thus having the function of constraining the protection elements to rotate together.

This solution has the advantage that it can be easily mounted on a roller already in place on the lateral profiled member. This being said, it does not fulfil its safety function completely because it is retained in position by being clipped onto the roller, which does not prevent fortuitous demounting of the protection element. Furthermore, such a solution cannot be adapted to be applicable to different values of the distance between the axes of the rollers unless the attachment means of the protection parts are adapted to connect them to one another and to retain them in place.

The document DE102019101473 describes a U-shaped protection element for conveyor rollers, comprising a support plate and two parallel cover plates that can be clipped onto the support plate. The support plate includes a hexagonal central opening enabling it to be fixed to the end of the shaft of the roller, which is also hexagonal, the two cover plates then partly covering the conveyor roller to prevent pinching. This protection element with the removable cover plates enables easy changing of the location of the rollers as the protection element is not fixed onto the profiled member of the conveyor. However, the support plate being retained in position only by the shaft of the roller that passes through a central opening, in the event of wear there exists a risk of the protection element becoming angularly offset and coming into contact with the drive belt connecting two rollers to one another.

The present disclosure therefore has the objective of alleviating at least in part the disadvantages of the prior art cited hereinabove.

In particular, one objective of the present disclosure is to propose a solution enabling effective protection of the zones between the belt and the roller where there is a risk of pinching. Furthermore, the proposed solution is aimed at not being able to be demounted inadvertently and at being able to be installed independently of the distance between the axes of the rollers.

### SUMMARY

The objectives mentioned hereinabove are achieved in particular by a protection part intended to equip a conveyor, the conveyor comprising:
a structure including two lateral profiled members between which a plurality of rollers extend transversely,
at least one of the rollers being driven in rotation by a motor, each roller including a rolling surface and flanks, each roller being mounted to pivot relative to the lateral profiled members via a mounting shaft, the mounting shaft including end portions projecting from the two flanks at the ends of the roller,
at least one drive belt connecting two of the rollers, the belt including an upper run and a lower run and in particular for each roller spaces between the upper run and the lower run of each belt and the roller defining pinch zones,
   said protection part comprising:
a base comprising an opening configured to have passed through it one of the end portions of one of the mounting shafts of one of the rollers, the base being located between one of the flanks of the roller and one of the two lateral profiled members,
two protection walls projecting from said base in the lengthwise direction of the roller, said protection walls extending on respective opposite sides of said roller between the lower run and the upper run of each of the belts so as to prevent access to the pinch zones of said roller, and
fixing means configured to retain said protection part on a lateral profiled member of the conveyor.

Thus the protection walls provide a particularly effective physical barrier around pinch zones situated between the upper and lower runs of the belts engaged on the roller.

Furthermore, the protection part, which includes both an opening through which the shaft of the roller passes and means for fixing it onto the lateral profiled member that retain it in a position between the lateral profiled member and a flank of the roller, cannot be demounted inadvertently. In fact, the design of the protection part renders it necessary, to demount it, to demount the roller first.

The protection part moreover including fixing means for retaining it on the profiled member, it is of no utility for the openings through which the shaft of the roller passes to participate in the retention of the part on the profiled member.

The features disclosed in the following paragraphs can optionally be used independently of one another or in combination with one another.

In accordance with one improvement the base, the two protection walls and where applicable the fixing means of the protection part are part of a monobloc body.

In accordance with one improvement the contour of said opening of the base has a closed section

In accordance with one improvement the base includes a groove in an over-depth of a wall of the base that faces the flank of the roller, said groove extending in a median direction to the two protection walls.

In accordance with one improvement the protection walls each comprise an internal face configured to be positioned facing said roller, said internal face of each of the protection walls being concave. The internal face then “espouses” the exterior shape of the roller.

In accordance with one improvement the fixing means are configured to cooperate with an attachment zone on the lateral profiled member, said attachment zone having a closed contour, the fixing means cooperating with the attachment zone through elastic deformation induced by movement in translation of the protection part in the lengthwise direction of the roller. In this way, the protection part is mounted and demounted in a direction parallel to the length of the roller. In some examples the fixing means cooperate with the attachment zone by nesting, by driving or by a tight fit.

In accordance with one improvement the fixing means include two attachment members situated on respective opposite sides of the opening in the base, the attachment members projecting from the base on the side of the base opposite the two protection walls, each of the two attachment members being configured to cooperate with an attachment zone of the lateral profiled member.

In accordance with one improvement the attachment members include teeth oriented toward one another, each tooth being configured to cooperate with a contour of the corresponding attachment zone, each attachment member extending in continuity with a protection wall so that movement of the two protection walls closer to one another generates a spacing of the two teeth from one another. The operation of mounting and demounting the protection part is therefore facilitated in that it does not necessitate any tools.

In accordance with one improvement the protection part is made by injection moulding plastic material.

The present disclosure further concerns a conveyor including a protection part as described above, the conveyor including:
a structure including two lateral profiled members between which a plurality of rollers extend transversely,
at least one of the rollers being driven in rotation by a motor, each roller including a rolling surface and flanks, each roller being mounted to pivot relative to the lateral profiled members via a mounting shaft, the mounting shaft including end portions projecting from the two flanks at the ends of the roller,
at least one drive belt connecting two of the rollers, the belt including an upper run and a lower run and, in particular, for each roller the spaces between the upper run and the lower run of each belt and the roller defining pinch zones,
   said protection part being mounted on the conveyor and comprising:
a base comprising an opening through which passes one of the end portions of one of the shafts of one of the rollers, the base being located between one of the flanks of the mounting roller and one of the two lateral profiled members,
two protection walls projecting from said base in the lengthwise direction of the roller, said protection walls extending on either side of said roller between the lower run and the upper run of each of the belts so as to prevent access to the pinch zones of said roller, and
fixing means retaining said protection part on the lateral profiled member of the conveyor.

In a particularly effective way the protection part is configured so that demounting it necessitates beforehand at least partial demounting of said roller from the lateral profiled members.

In accordance with one improvement the contour of the opening in the base of the protection part is everywhere distant from the end portion of the mounting shaft of the roller, preferably at a distance between 0.5 and 6 mm.

In accordance with one improvement each of the protection walls of said protection part includes an internal face facing said roller, said internal face being distant from said roller at a distance d between 1 and 10 mm in a radial direction of the roller.

In accordance with one improvement the conveyor includes first and second protection parts, the first protection part equipping a first roller and the second protection part equipping a second roller adjacent to the first roller, a first attachment member of the first protection part and a second attachment member of the second protection part both cooperating with one and the same attachment zone of said lateral profiled member.

The present disclosure further concerns a method for mounting a protection part as described above on a conveyor, said conveyor including:
a structure including two lateral profiled members between which a plurality of rollers extend transversely,
at least one of the rollers being driven in rotation by a motor, each roller including a rolling surface and flanks, each roller being mounted to pivot relative to the lateral profiled members via a mounting shaft, the mounting shaft including end portions projecting from the two flanks at the ends of the roller,
at least one drive belt connecting two of the rollers, the belt including an upper run and a lower run and, in particular, for each roller the spaces between the upper run and the lower run of each belt and
the roller defining pinch zones,
   the mounting method including:
fixing said protection part onto a lateral profiled member by cooperation between the fixing means and one of the lateral profiled members,
passing one of the end portions of the mounting shaft of one of said rollers through said opening in the base of the protection part already fixed onto the lateral profiled member.

### BRIEF DESCRIPTION OF THE DRAWINGS

Other features, details and advantages will become apparent on reading the following detailed description and analysing the appended drawings, in which:

FIG. 1 is a diagrammatic perspective view of one example of a roller conveyor.

FIG. 2 is a diagrammatic representation of one example of two rollers connected by a belt and two protection parts mounted on a profiled member.

FIG. 3 is a diagrammatic representation of one example of three rollers, as seen in a direction parallel to the lengthwise axis of the rollers, highlighting the location of the pinch zones.

FIG. 4 is a diagrammatic perspective view of one example of a protection part, the figure proposing two views A and B respectively showing the part as seen from in front and from behind.

FIG. 5 is a diagrammatic view in section on a horizontal plane passing through the opening of the base of one example of a protection part.

FIG. 6 is a diagrammatic perspective view of one example of a profiled member on which is formed a plurality of attachment zones and on which are mounted a protection part and a roller.

FIG. 7 is a diagrammatic perspective view of one example of a method of mounting one example of a protection part on a profiled member.

FIG. 8 is a diagrammatic front view as seen in a direction parallel to the axis of a roller of one example of a protection part when it is mounted on a profiled member.

FIG. 9 is a schematic perspective view of one example of a method of mounting a roller on a profiled member when a protection part is already in position on the profiled member.

FIG. 10 is a diagrammatic perspective view of a set of two rollers connected by a belt and two protection parts mounted on one example of a profiled member in which the rear of the profiled member is particularly clearly seen.

FIG. 11 is a diagrammatic representation of one example of mounting two adjacent protection parts sharing a common attachment zone. The figure proposes two views A and B respectively showing a rear view of a profiled member on which two protection parts are mounted in this example and a view in section on a horizontal plane intersecting the two adjacent fixing means of the two protection parts.

FIG. 12 is a diagrammatic view in section on a plane transverse to the lengthwise direction of the rollers positioned at the level of guide portions of the rollers in which can at least partly be seen one example of three rollers and three protection parts, the radial distance between the protection walls and the roller being particularly easily seen.

### DETAILED DESCRIPTION

The drawings and the description hereinafter essentially cover elements of a certain character. They could therefore serve not only to provide a better understanding of the present disclosure but also contribute to its definition if necessary.

In the various figures the same references designate identical or similar elements. For conciseness only elements that are useful for understanding the embodiment described are represented in the figures and described in detail hereinafter.

In the following description, absolute position qualifiers such as “front”, “rear”, “high”, “low”, “left”, “right”, etc. or relative position qualifiers such as “above”, “below”, “upper”, “lower”, etc. or orientation qualifiers such as “horizontal”, “vertical”, etc. refer unless otherwise specified to the orientation seen in the figures or a warehouse conveyor in its normal position of use.

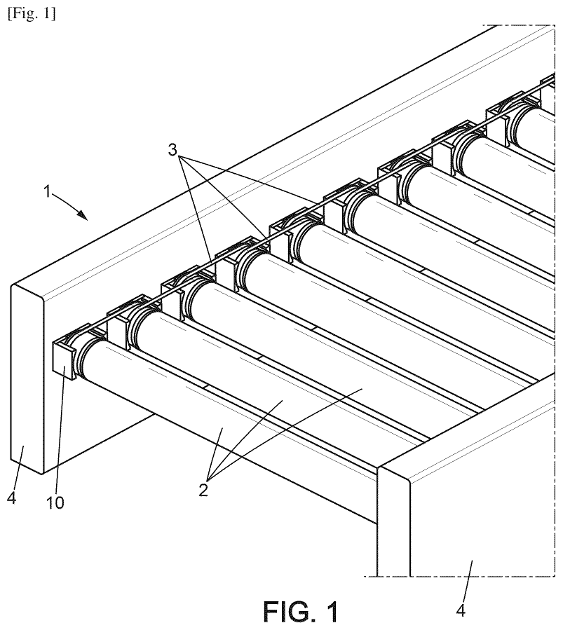

Refer now to FIG. 1, which shows one example of a conveyor 1. The conveyor typically comprises a structure including two lateral profiled members 4 between which rollers 2 extend transversely. To enable the conveyor to rest on the floor the structure can further include means such as legs (not represented).

In some examples at least one of the rollers 2 is driven in rotation by a motor (not represented) and the rollers 2 are connected two by two by a plurality of belts 3. A single motor is therefore sufficient for each of the rollers to be driven in rotation and enables goods to be routed along the conveyor.

It is possible for the distance between the axes of the rollers 2 to be constant over the whole of a portion of the conveyor, as is the case in the example represented in FIG. 1. It is equally possible for the distance between axes to vary over a portion of the conveyor or from one conveyor to another.

In some examples each roller 2 is connected to two directly adjacent rollers 2 by two belts. In this way, each roller 2 receives two belts 3 extending in opposite directions.

Each roller 2 includes a rolling surface 22 and lateral flanks 23 (see FIG. 9). The rolling surface 22 can typically be a circular cylinder. The lateral flanks 23 can be plane, typically circular surfaces that close the ends of the rolling surface 22. In some examples the flanks 23 extend in plane normal to a lengthwise direction of the roller 2. This lengthwise direction can typically extend along the axis of revolution of the surface of the cylindrical roller.

In some examples the flanks 23 of each roller 2 extend substantially parallel to the lateral profiled members 4 and face the latter. Thus each flank 23 can be at a distance from the corresponding lateral profiled member 4 between 5 and 10 mm for example.

Each roller 2 can be mounted to pivot relative to the lateral profiled members 4 via a mounting shaft 21. The mounting shaft 21 can comprise end portions 211 that project from the two flanks 23 at the ends of the roller 2. The end portions 211 can extend in the lengthwise direction of the roller 2 and/or extend normally to the flanks 23. The end portions 211 can have a circular or polygonal, for example hexagonal shape cross section.

In some examples each roller 2 can include a rotating body carrying the rolling surface 22 and able to pivot about a mounting shaft 21. The mounting shaft 21 is then mounted at each of its two end portions 211 on the two lateral profiled members 4 in such a manner that it is prevented from rotating.

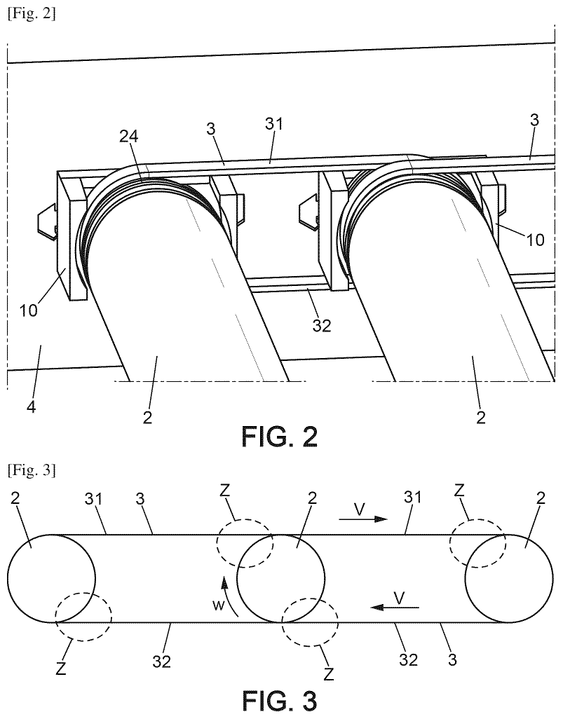

Each belt of the plurality of drive belts 3 connecting the rollers 2 two by two includes an upper run 31 and a lower run 32. As represented in FIGS. 2 and 3 the upper run 31 extends above the rollers 2 and the lower run 32 extends below the rollers 2. In this way, for the same belt 3, the upper run 31 is driven in translation in the opposite direction to the lower run 32 of the same belt 3. In particular, for each roller 2 the spaces between the upper run 31 and the lower run 32 of each belt 3 and the roller 2, or to be more precise the roller surface 22 of the roller 2, define pinch zones Z (represented in FIG. 3).

However, given the directions in which the upper run 31 and the lower run 32 move in translation, there can be distinguished for each roller 2 a zone in which one run comes toward the roller and another zone in which the other run of the same belt departs from the roller 2. These are the zones in which the run comes toward the roller 2 where there is a risk of pinching, the run then being able to drag a finger of an operator toward the roller 2 and pinch it. These different pinch zones Z are represented in FIG. 3 as a function of translation directions V and a direction w of rotation of the roller.

Each roller 2 can include a drive portion 24 in which the belts 3 come into contact with the roller 2. The drive portion 24 can typically be an end part of the rolling surface 22 adjacent to a flank 23 of the roller. In some examples this drive portion 24 can have a width greater than twice the width of a belt 3. The same drive portion 24 can receive two belts 3 side by side, one connecting said roller 2 to an adjacent roller on a front side and the other connecting said roller 2 to another roller on the rear side, as represented in FIGS. 2 and 3.

In some examples the drive portion 24 can be configured to improve the friction with the belt 3 and therefore the effectiveness of the transmission of torque, for example by including indentations or striations adapted to cooperate with complementary shapes of the belts or by having a high surface roughness relative to the rolling surface 22 of the roller 2.

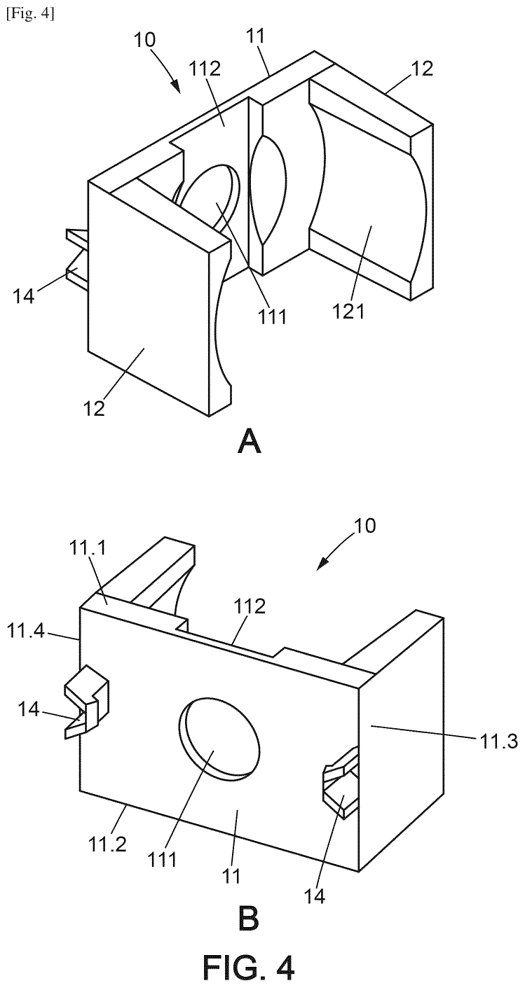

FIG. 4 represents in two distinct views A and B a protection part 10 in accordance with one example of the present disclosure.

The protection part 10 includes a substantially plane base 11. Said base 11 includes an opening 111 configured to have passed through it an end portion 211 of the mounting shaft 21 of a roller 2. In this way, once mounted on a conveyor the base 11 is in the space left free between a flank 23 of the roller 2 and the corresponding lateral profiled member 4. In some examples the base 11 may have an “overall” thickness between 1 and 8 mm.

In some examples when the roller 2 and the protection part 10 are mounted on the profiled member 4 the contour of the opening 111 in the base is at every point distant from the end portion 211 of the mounting shaft 21. In other words the opening 111 in the base is not configured to be in contact with the roller 2 once the protection part 10 and the roller 2 have been mounted on the profiled member 4. For example the opening 111 can include a contour of circular shape with a diameter greater than the greatest diameter of a cross section of the shaft 21.

In some examples the base 11 may include an upper side 11.1 and a lower side 11.2, a front side 11.3 and a rear side 11.4.

Furthermore, the protection part 10 also includes two protection walls 12 that project from the base 11. The lengthwise direction of the protection walls 12 can be parallel to a lengthwise direction of the roller 2. The lengthwise direction of the protection walls 12 can be perpendicular to a plane formed by the base 11. Once the protection part 10 has been mounted on a conveyor these protection walls 12 are configured to extend on respective opposite sides of the corresponding roller 2.

In other words the protection walls 12 delimit the front and the rear of a space configured to receive the roller 2.

In some examples the base 11 extends in such a way that its front and rear sides project from the rolling surface of the roller 2. The length of the base measured from its front side 11.3 to its rear side 11.4 can typically be greater than a diameter of the roller 2. In this way the two protection walls 12 can extend from the front side 11.3 and the rear side 11.4 of the base 11 on respective opposite sides of the roller 2.

In some examples the drive portion 24 of the roller 2 extends over a certain length of the roller, for example a length sufficient to receive two belts 3 side by side. It is then possible for the protection walls 12 to extend over a length sufficient to cover the drive portion 24 of the roller 2. Otherwise, in some examples the protection walls 12 can extend in the lengthwise direction of the roller 2 over a length at least greater than twice the width of a run of the belt 3.

It is furthermore possible for each roller 2 to include a drive portion 24 at each of its two ends.

The protection walls 12 are configured to make a physical barrier to prevent access to the pinch zones Z between the belts and the rollers. In this way each protection wall 12 extends between the upper run 31 and the lower run 32 of each of the belts 3 engaged with the roller 2 at the level of which the protection part 10 is mounted. Examples of such a configuration can more particularly be seen in examples in FIGS. 2, 10 and 12.

In an example that is not represented, the upper and lower portions of the protection walls 12 extend in the lengthwise direction of the roller 2 over a length greater than that of the median portions of the protection walls. In this way, the protection walls do not impede the rotation of the roller and prevent access to the pinch zones Z.

In some examples the base 11 has a height as measured from its upper side 11.1 to its lower side 11.2 that can be less than the diameter of the rolling surface 22 of the roller 2. In this way the protection walls 12 that can extend over all of the height of the front and rear sides of the base 11 also have a height less than the distance between the upper run 31 and the lower run 32 of the corresponding belt 3.

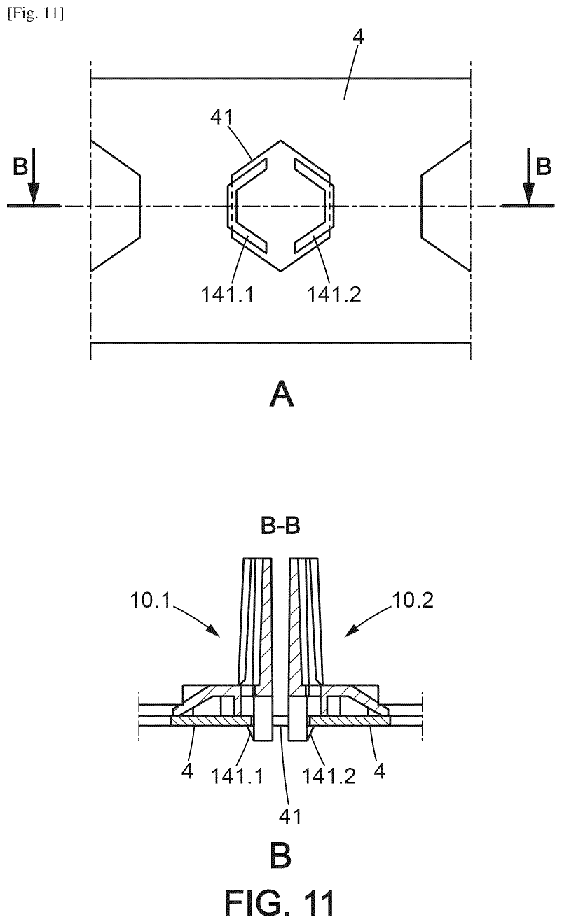

In some examples the protection walls 12 can include an internal face 121 facing the roller 2. This internal face 121 can be concave so as to “espouse” the cylindrical exterior shape of the roller 2 (see also FIG. 11). In other words the shape of the internal surface 121 of the protection walls 12 is in geometrical correspondence with the exterior shape of the roller 2. This shape is advantageous in that it enables the rolling surface of the roller to be followed as closely as possible, for greater safety. However, it is possible to provide other alternative shapes of the protection walls 12, for example a shape comprising a vertical plane wall and two walls oblique or perpendicular to the plane wall approaching the roller 2.

Furthermore, the protection part 10 also includes fixing means 14 configured to retain it on the corresponding lateral profiled member 4 of the conveyor 1. These fixing means 14 further prevent rotation of the protection part 12 relative to the lateral profiled member 4. Thus it is not necessary to match the shape of the opening 111 in the base 11 to the shape of the end portion 211 of the mounting shaft 21.

In some examples the fixing means 14 are adapted to cooperate with an attachment zone 41 having a closed contour for example, the attachment zone being formed on the lateral profiled member 4. The attachment zone 41 can be obtained by punching the profiled member or by any appropriate cutting means to obtain an opening through the profiled member. In some examples the fixing means 14 include two attachment members 141, 142, each adapted to cooperate with an attachment zone 41 of the corresponding lateral profiled member 4. The attachment members 141, 142 can for example project from the base 11 on a side of the base opposite the two protection walls 12.

In some examples the attachment members 141, 142 project from the base 11 over a length chosen so that withdrawing said attachment members 141, 142 out of their respective attachment zone 41 necessitates a movement in translation along the shaft of the roller over a travel greater than the maximal clearance between a flank 23 of the roller 2 and the profiled member 4 plus the thickness of the base 11. In this way, if it is intended to demount the protection part 10, when the roller 2 is in place on the profiled member and through the opening 111, which has an open contour for example, there is not sufficient space between the flank 23 of the roller and the profiled member to extirpate the protection part 10 and to be precise its attachment members 141, 142 out of the attachment zones 41 of the profiled member. In fact the base of the protection part will come to abut against the flank 23 of the roller before the attachment members 141 are completely withdrawn from the attachment zones 41 and it will then be impossible to demount the protection part 10 without first removing the roller, for even greater safety.

In some examples the attachment members 141, 142 can be adapted to be elastically deformed at least in part so as to cooperate with the attachment zones 41. In some examples such deformation can be induced by a movement in translation in the lengthwise direction of the rollers 2, that is to say perpendicularly to the plane of the profiled member 4. In some examples the deformation is caused by an angled surface on the attachment member enabling movement in translation to be transformed into transverse deformation of the attachment member, for example in the manner of a clip.

In some examples the attachment zones 41 on the lateral profiled member 4 are of polygonal, in particular hexagonal shape. It is advantageously possible for the mounting shaft 21 of the roller 2 to be mounted on the profiled member 4 via one of these attachment zones 41. It is therefore possible with the same tool to produce a plurality of attachment zones 41 on the profiled member 4 each of which can be used independently to mount the roller 2 or to mount the protection part 10.

The shape of the attachment zones 41 can advantageously be the same as the shape of a cross section of the end portion 211 of the shaft about which the roller 2 pivots so as to prevent rotation of the mounting shaft 21 relative to the profiled member 4. In one example, the attachment zones 41 and the end portions 211 are the same shape, for example hexagonal.

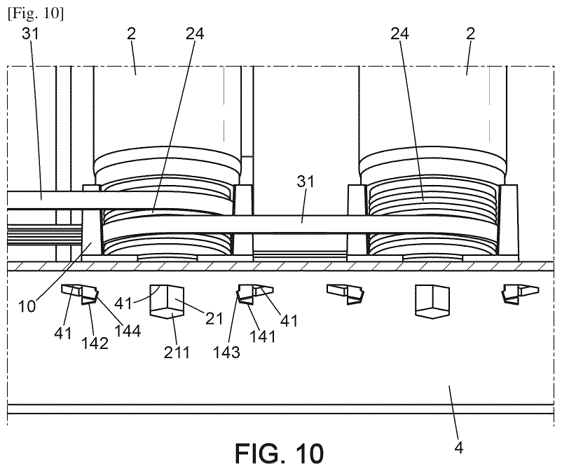

In some examples the attachment members 141, 142 can be situated on respective opposite sides of the opening 111 in the base 11, at the level of each of the front side 11.3 and the rear side 11.4 of the base 11. Thus as shown in FIG. 10 three consecutive attachment zones 41 on the profiled member 4 are used, in this order, to mount a first attachment member 141, then to mount the shaft 21 of the roller 2, finally to mount a second attachment member 142 of the protection part.

The attachment members 141, 142 are advantageously situated substantially equidistantly from the upper side 11.1 and the lower side 11.2 of the base 11 and the protection part 10 does not impose a mounting direction on the profiled member 4.

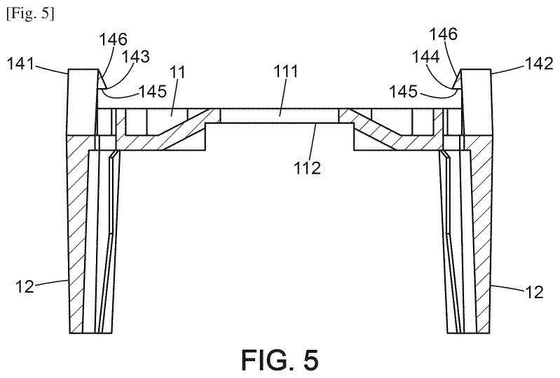

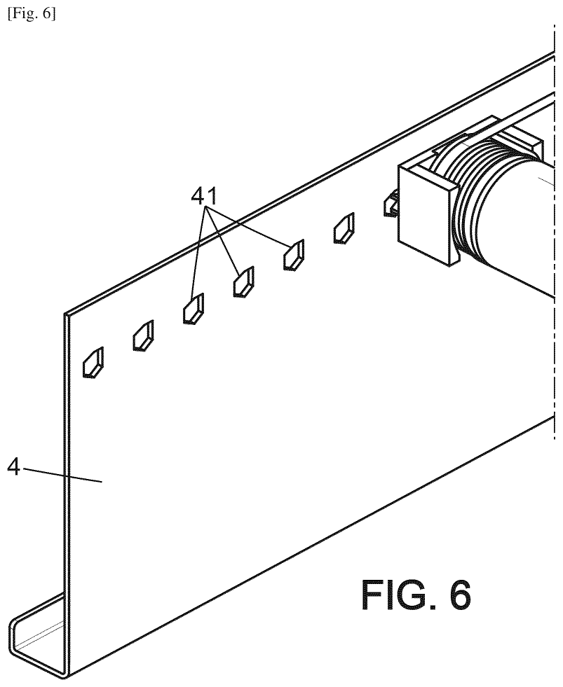

In some examples, and in particular like that represented in FIG. 5, the attachment members 141, 142 can include teeth 143, 144 oriented toward one another. In other words the tooth 143, 144 of the attachment member 141, 142 is oriented toward the interior or toward the opening 111. Each tooth 143, 144 can be configured to cooperate with a contour of the corresponding attachment zone 41. In fact, each tooth can have an abutment surface 145 facing the base 11, the space formed between the abutment surface 145 and the base 11 being configured to accommodate the thickness of the lateral profiled member 4 on which the protection part 10 is mounted. In one example the tooth 143, 144 can have an angled surface 146 adapted to transform a movement in translation of the attachment member 141, 142 across the attachment zone 41 into a transverse elastic deformation of said member by contact between the angled surface 146 and the profiled member 4, in the manner of a clip.

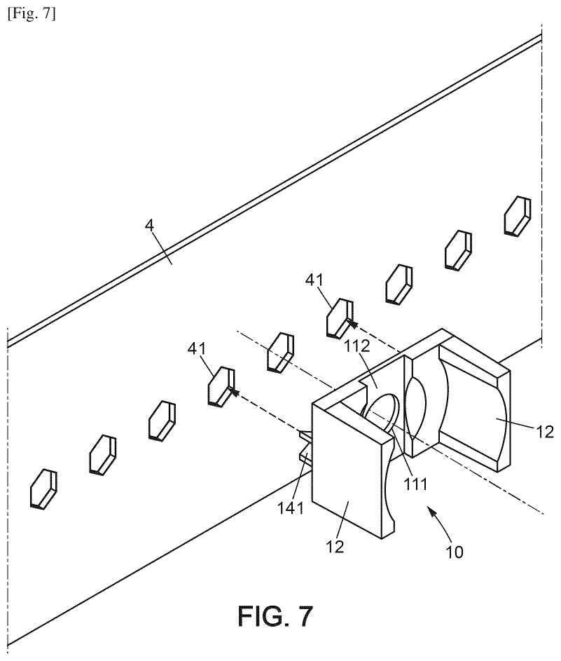

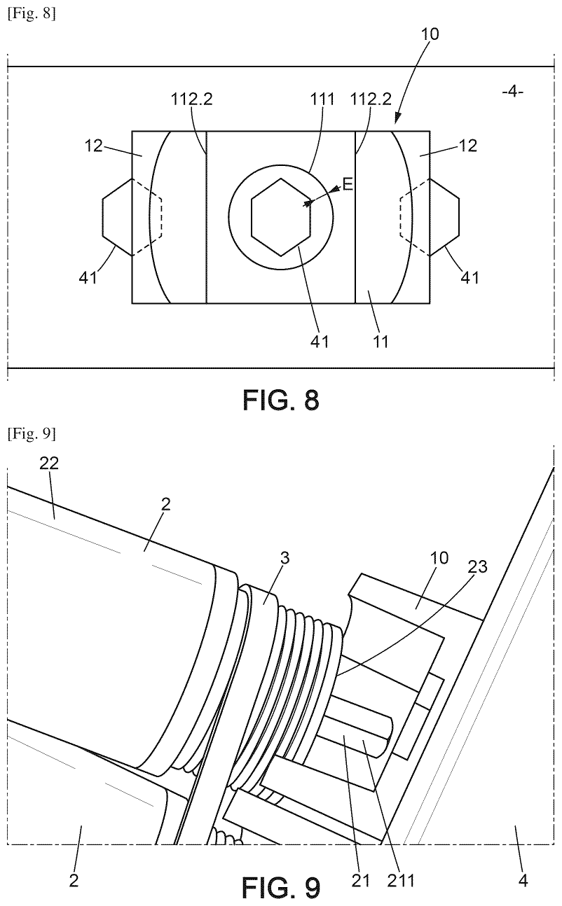

An example of a method of mounting the protection part 10 and the roller 2 is represented in FIGS. 7 and 8.

In some examples the contour of the attachment zones 41 is a closed contour, which implies that the cooperation between the attachment means 14 and the profiled member 4 to retain the protection part 10 in position is produced by moving the part 10 at least partially closer in a direction parallel to the lengthwise direction of the rollers 2, that is to say perpendicularly to the plane formed by the profiled members 4.

In the example represented in FIG. 7 the part is moved closer in a direction perpendicular to the plane of the profiled member 4 so that the attachment members 141, 142 pass through the attachment zones 41. Once they have passed a rear side of the profiled member 4, the abutment surface 145 of the teeth 143, 144 retain the protection part against the profiled member 4. Once mounted, the base 11 is then pressed against the profiled member 4.

The roller 2 can then be mounted. If it is a second roller 2 adjacent to a first roller already mounted, the second roller is moved toward the opening 111 with the belt 3 connecting it to the roller and where applicable with another belt 3 (not represented) which can be provided to connect the next roller. The upper run 31 of the belt 3 is then placed above an upper side of the protection wall 12 on the side of the first roller and the lower run 32 placed below a lower side of the same protection wall 12. The roller 2 is then moved closer so that an end portion 211 of the mounting shaft 21 of the roller is positioned facing the opening 111 in the base 11 of the protection part 10 already mounted. The attachment zone 41 that is designed to receive the mounting shaft 21 of the roller is then accessible through the opening 111. The attachment zone 41 of the profiled member and the opening 111 of the protection part 10, once mounted, can advantageously be substantially concentric. Alternatively, the entirety of the attachment zone 41 is included in the contour of the opening 111. The mounting shaft 21 is then inserted through the opening 111 and then through the attachment zone 41. The attachment zone 41 can then be configured, in particular through complementary shapes, to stop rotation of the mounting shaft 21. The base 11 of the protection part 10 is then located between the profiled member 4 and the flank 23 of the roller 2 that passes through it.

One example of the protection part 10 mounted on the profiled member 4 is represented in FIG. 8. Once mounted, the attachment zone 41 for mounting the shaft 21 is accessible through the opening 111.

In the present disclosure the opening 111 is not designed to be in contact with the shaft 21 while the roller is mounted and does not participate in fixing the protection part 10, the latter being retained on the profiled member 4 only by the fixing means 14. A functional clearance E can therefore be provided that can be between 0.5 and 6 mm between the contour of the opening 111 and the mounting shaft 21. Such a clearance can also be useful for absorbing any manufacturing tolerances of the attachment zones 41, which could result in off-centring of the attachment zone 41 relative to the opening 111.

The opening 111 enables the attachment zone 41 to remain accessible when the base 11 is pressed against the profiled member 4. The opening 111 further enables prevention of demounting of the protection part 10 if the roller 2 has not been at least partially demounted beforehand, in particular by withdrawing the end portion 211 of the shaft 21, from the lateral profiled member 4, on the side of the protection part to be removed, thereafter to allow the withdrawal of the end portion 211 from said opening 111 in the base of the protection part.

To this end said opening 111 can have a closed contour. The opening 111 in the protection part is then threaded onto the end portion 211 of the roller 2, the contour of the opening physically preventing withdrawal of the protection part 10 from the shaft in a direction perpendicular to the shaft. The closed contour in fact necessitates that the part is disengaged by a movement along the shaft as far as a free end of the end portion. In the mounted position the roller passes through the profiled member and this free end is then inaccessible, being situated on a rear side of the profiled member.

If the contour is not closed, i.e. if the contour includes a portion opening onto a side of the base, that portion is arranged in a position on the base and/or is sized so that it does not allow extraction of the protection part by causing the shaft to escape via this open contour portion, for example by including a portion of reduced width less than a transverse dimension of the shaft.

In some examples the profiled member 4 can include attachment zones 41 that are regularly spaced, that is to say in a configuration that is repeated every three attachment zones 41, for example, so that once mounted by means of the fixing means 14 the protection part 10 has its opening 111 aligned facing an attachment zone 41. In other examples the adjacent attachment zones 41 can be spaced two by two by a constant distance. Such a distance can for example be substantially equal to half the length of the base 11 as measured from its front side 11.3 to its rear side 11.4.

In some examples and in particular as represented in the examples shown in FIGS. 4, 5 and 8 the protection part can include a recess, for example a groove 112 on the base 11 to facilitate mounting the roller 2. In fact it is possible for the rollers 2 to be mounted when the profiled members 4 are already in place. Thus the distance that separates the profiled members 4 is imposed, and the additional thickness added by the two protection parts 10 can make it difficult to mount the roller 2 between the two profiled members. To this end, the groove 112 can be in an over-depth of a wall of the base facing the flank 23 of the roller 2, in particular on the side of the base 11 opposite that which is mounted against the profiled member 4. The groove 112 can be designed so that it extends in a mounting direction of the shaft 21 of the roller 2, for example a median direction with respect to the two protection walls 12 passing through the opening 111, which corresponds to a direction of the mounting shaft 21 toward the opening 111. The groove 112 can extend over at least a portion of the height of the base 11. For example, the groove 112 can extend from an upper side to a lower side of the base 11 across the opening 111.

The groove 112 is therefore configured to prevent interference between the shaft 21 and the protection part 10 when the end portion 211 of the mounting shaft 21 is moved as far as said opening 111 prior to its insertion through the opening 111 and the attachment zone 41. In some examples the groove 112 can extend from the upper or lower side of the base 11 at least as far as the opening 111 and can also extend beyond said opening 111, for example as far as the other, upper or lower side, so that the protection part 10 does not impose a direction of mounting on the profiled member or a direction of mounting of the roller 2. In some examples the groove 112 can have a width from a front edge 112.1 to a rear edge 112.2 greater than or equal to the width of the opening 111, typically greater than the diameter of the opening 111 when the latter is circular (see FIG. 8).

Mounted in this way the protection part 10 cannot be demounted inadvertently since it has a roller 2 pass through it and is mounted on the profiled member 4 by attachment means 14 the demounting kinematic of which parallel to the axis of the roller is blocked by a flank 23 of the same roller 2. It is then necessary to demount the roller 2 at least partially to be able to demount the protection part 10.

In some examples the protection part can be a monobloc part. That is to say the base 11, the protection walls 12 and where applicable the attachment means 14 form part of the same monobloc body. In other words the protection part is made in one piece. Alternatively the protection part can be made of two or more parts joined together.

In some examples the protection part 10 can be an injection moulded plastic. It is also possible to obtain it by any other means known to the person skilled in the art, for example by casting and/or machining metal.

In some examples the protection part 10 has a shape featuring at least one symmetry. In particular it can include two orthogonal planes of symmetry: the median plane of the two protection walls 12 that passes through a centre of the opening 111 and the plane orthogonal to that median plane at the level of the opening 111. In this way the protection part 10 has a geometry that does not vary independently of its direction of mounting on the profiled member 4, therefore limiting the risks of error during its installation on the conveyor.

In some examples the opening 111 can have a closed contour so that the only way for the protection part 10 to be withdrawn from a mounting shaft 21 of a roller 2 is to be extracted therefrom by movement in a direction parallel to the axis of the shaft 21. Additionally, in some examples the base 11 can be of monobloc construction. In this way, the mounting of the protection part 10 is even safer, the mounting shaft 21 having to be completely withdrawn from its attachment zone 41 before demounting the protection part 10.

In some examples each attachment member 141, 142 extends in continuity with a protection wall 12 on the other side of the base 11 so that moving the two protection wall 12 closer generates a spacing of the two teeth 143, 144 relative to one another. Such an effect can for example be obtained by a reduction of thickness at the level of the base of the protection walls 12 in such a manner as to enable sufficient flexibility of the part. The bases of the protection walls 12 then act as pivot points enabling pinching of the protection walls 12 to move the teeth 143, 144 away from one another. Such a spacing facilitates inserting the attachment members 141, 142 through attachment zones 41, releasing of the walls 12 then allowing the teeth 143, 144 of the attachment members to sandwich the profiled member 4 to hold the protection part 10 in position. This solution can be additional to or an alternative to the presence of the angled surface 146 on the attachment members.

Refer now to FIG. 10, which represents one example of a set of two rollers 2 and two protection parts 10 mounted on a profiled member 4. In this example the assembly occupies six attachment zones 41. It is equally possible to space the two rollers farther apart, for example leaving an attachment zone unoccupied between the two rollers 2 or a plurality of attachment zones unoccupied. It is equally possible to provide two spaced groups each comprising three attachment zones. In a manner that is particularly visible in this example the upper run 31 of the belt 3 connecting the two rollers 2 passes over the front and rear protection walls of the two protection parts 10.

In some examples the two attachment members 141, 142 can each have a shape that is symmetrical to the other so that two attachment members 141, 142 of two adjacent protection parts 10 can occupy the same attachment zones 41 without interfering with one another. Such a solution can be advantageous in that it can minimise the number of attachment zones 41 of the profiled number 4 or in that it enables the rollers to move closer to one another. Such a configuration is represented in an example shown in FIG. 11. In this example the attachment members 141.1, 141.2 of two adjacent protection parts 10.1, 10.2 each have the shape of a half-hexagon which, once juxtaposed, are adapted to cooperate with the same attachment zone 41 without impeding one another, each being engaged with a front and rear portion respectively of the contour of the attachment zone 41. In this way, five attachment zones can be sufficient to fix two rollers 2 and two adjacent protection parts 10.1, 10.2. The rollers 2 are particularly close to one another.

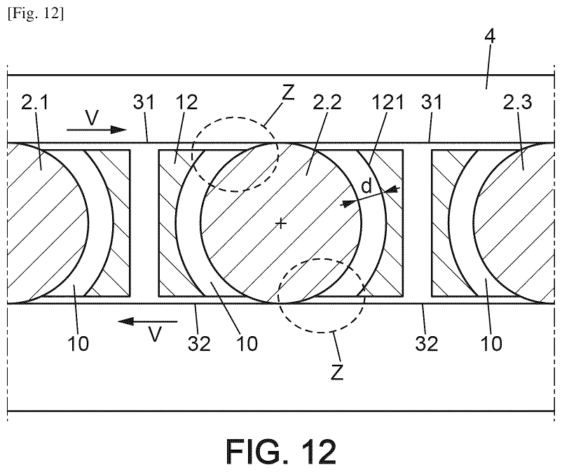

Refer now to FIG. 12, which is a view in cross section of the rollers of an example with three adjacent rollers 2.1, 2.2, 2.3. The protection walls 12 of the protection parts 10 in this example have a concave internal face 121 that follows the curvature of the cylindrical shape of the rollers 2. The internal faces 121 of the protection walls 12 are in this example distant from the exterior surface of the rollers 2 at a distance d measured radially relative to the axis of revolution of the roller 2. In some examples the distance d can be between 1 and 10 mm. In this way, the internal face does not impede the movement of the roller 2 or of the belt between the roller and the protection wall 10, but anyway prevents access, for example by a finger, to the pinch zones Z. The distance d can preferably be between 3 and 5 mm. As a general rule the distance d can be less than the dimension of a finger.

In some examples and as represented in FIG. 12 the protection walls 12 extend between the upper runs 31 and the lower runs 32 of the belts 3 over all of the height that separates the two runs. Alternatively the protection walls 12 can extend only in an upper part in the vicinity of the upper run 31 on the front side of the roller 2 and in the lower part, in the vicinity of the lower run 32 on the rear side of the roller 2 so as to cover only the zones in which the run goes toward the roller 2 and represents a risk of pinching, then leaving zones in which the run departs from the roller since the movement of the run away from the roller can naturally prevent any pinching in these zones.

Thus the protection part according to the present disclosure or the conveyor equipped with said protection part has some or all of the following advantages:
The protection part has a geometry enabling it, once mounted on the conveyor, to be difficult to demount without demounting the roller first. In particular, it is located between a flank of the roller and the profiled member, its protection wall extend on either side of the roller, it includes an opening through which the shaft of the roller passes, and means for fixing it onto the profiled member. Together these features render it difficult to demount this part which provides more reliably than existing solutions its safety function of protection of pinch zones.
An improvement whereby the protection part is a monobloc part makes it more difficult to demount the part if the roller is in place. In fact, this optional feature prevents facilitation of demounting of the part by removing from it one or more demountable parts, for example its protection walls, for greater safety.
A further improvement whereby the opening has a closed contour enabling physical locking of the part that is then threaded onto the shaft. Ordinarily, even if it can have an opening contour, the opening effectively impedes demounting the protection part. In situations where the contour is closed, the part must be disengaged by the free end of the shaft, which is physically inaccessible when the shaft is mounted on the profiled member. If the protection part according to the present disclosure has a design that renders demounting difficult, this improvement renders it impossible without first demounting the roller.
Furthermore, the mounting of the protection part is totally independent of the distance between axes that separates the rollers. It therefore has the advantage over existing solutions of perfectly adapting to different distances between roller axes.
Of simple design, produced in accordance with one improvement by moulding a plastic material, the proposed part has a reduced cost and great reliability.
Furthermore, in one improvement the fixing means is designed to be easy to mount on the profiled member in a single operation and without tools. In the same way, if the rollers have been removed beforehand, the fixing means is also easily demountable without using tools.

1-14. (canceled)

15. A protection part intended to equip a conveyor, the conveyor comprising:
a structure including two lateral profiled members between which a plurality of rollers extend transversely,
at least one of the rollers being driven in rotation by a motor, each roller including a rolling surface and flanks, each roller being mounted to pivot relative to the lateral profiled members via a mounting shaft, the mounting shaft including end portions projecting from the two flanks at the ends of the roller,
at least one drive belt connecting two of the rollers, the belt including an upper run and a lower run and in particular for each roller spaces between the upper run and the lower run of each belt and the roller defining pinch zones (Z),
said protection part comprising:
a base comprising an opening configured to have passed through it one of the end portions of one of the mounting shafts of one of the rollers, the base being located between one of the flanks of the roller and one of the two lateral profiled members,
two protection walls projecting from said base in the lengthwise direction of the roller, said protection walls extending on respective opposite sides of said roller between the lower run and the upper run of each of the belts so as to prevent access to the pinch zones (Z) of said roller, and
fixing means configured to retain said protection part on a lateral profiled member of the conveyor.

16. The protection part according to claim 15 in which said base, the two protection walls and where applicable the fixing means are part of a monobloc body.

17. The protection part according to claim 15 wherein the contour of said opening of the base has a closed section.

18. The protection part according to claim 15 in which the base includes a groove in an over-depth of a wall of the base that faces the flank of the roller, said groove extending in a median direction to the two protection walls.

19. The protection part according to claim 15 wherein the protection walls each comprise an internal face configured to be positioned facing said roller, said internal face of each of the protection walls being concave.

20. The protection part according to claim 15 in which the fixing means are configured to cooperate with an attachment zone on the lateral profiled member, said attachment zone having a closed contour, the fixing means cooperating with the attachment zone through elastic deformation induced by movement in translation of the protection part in the lengthwise direction of the roller.

21. The protection part according to claim 15 in which the fixing means include two attachment members situated on respective opposite sides of the opening in the base, the attachment members projecting from the base on the side of the base opposite the two protection walls, each of the two attachment members being configured to cooperate with an attachment zone of the lateral profiled member.

22. The protection part according to claim 21 in which the attachment members include teeth oriented toward one another, each tooth being configured to cooperate with a contour of the corresponding attachment zone, each attachment member extending in continuity with a protection wall so that movement of the two protection walls closer to one another generates a spacing of the two teeth from one another.

23. The protection part according to claim 15 produced by injection moulding plastic material.

24. A conveyor including the protection part according to claim 15, said conveyor further including:
a structure including two lateral profiled members between which a plurality of rollers extend transversely,
at least one of the rollers being driven in rotation by a motor, each roller including a rolling surface and flanks, each roller being mounted to pivot relative to the lateral profiled members via a mounting shaft, the mounting shaft including end portions projecting from the two flanks at the ends of the roller,
at least one drive belt connecting two of the rollers, the belt including an upper run and a lower run and, in particular, for each roller the spaces between the upper run and the lower run of each belt and the roller defining pinch zones (Z).

25. The conveyor according to claim 24 in which the contour of the opening in the base of the protection part is everywhere distant from the end portion of the mounting shaft of the roller, preferably at a distance E between 0.5 and 6 mm.

26. The conveyor according to claim 24 in which the protection walls of said protection part each includes an internal face facing said roller, said internal face being distant from said roller at a distance d between 1 and 10 mm in a radial direction of the roller.

27. The conveyor according to claim 24 including first and second protection parts, the first protection part equipping a first roller and the second protection part equipping a second roller adjacent to the first roller, a first attachment member of the first protection part and a second attachment member of the second protection part both cooperating with one and the same attachment zone of said lateral profiled member.

28. A method for mounting the protection part according to claim 15 on a conveyor, said conveyor including:
a structure including two lateral profiled members between which a plurality of rollers extend transversely,
at least one of the rollers being driven in rotation by a motor, each roller including a rolling surface and flanks, each roller being mounted to pivot relative to the lateral profiled members via a mounting shaft, the mounting shaft including end portions projecting from the two flanks at the ends of the roller,
at least one drive belt connecting two of the rollers, the belt including an upper run and a lower run and, in particular, for each roller the spaces between the upper run and the lower run of each belt and the roller defining pinch zones (Z),
the mounting method including:
fixing said protection part onto a lateral profiled member by cooperation between the fixing means and one of the lateral profiled members,
passing one of the end portions of the mounting shaft of one of said rollers through said opening in the base of the protection part already fixed onto the lateral profiled member.
